(19) United States
(12) Patent Application Publication
(10) Pub. No.: US 2004/0025023 A1
(43) Pub. Date: Feb. 5, 2004

(54) Watermarking application system for broadcast contents copyright protection

(76) Inventors: Takaaki Yamada, Osaka (JP); Hiroshi Yoshiura, Tokyo (JP); Isao Echizen, Yokohama (JP); Shuichi Tago, Abiko (JP); Seiichi Goshi, Inagi (JP); Kazuto Ogawa, Zama (JP); Itsuro Murota, Tokyo (JP); Go Otake, Isehara (JP)

Correspondence Address: MCDERMOTT WILL & EMERY, 600 13TH STREET, N.W., WASHINGTON, DC, 20005-3096, US

(21) Appl. No.: 10/411,393

(22) Filed: Apr. 11, 2003

(30) Foreign Application Priority Data
Jul. 31, 2002 (JP) 2002-222376

(51) Int. Cl. H04N 7/167

(52) U.S. Cl. 713/176; 380/201

(57) ABSTRACT

A system for distributing broadcast contents, in which the copyright of the broadcast contents can be protected, is provided. The system is a watermarking application system for broadcast contents copyright protection, constituted by a broadcasting station of broadcast contents, a broadcasting receiver of the broadcast contents, a network monitoring agent for monitoring secondary contents of the broadcast contents, a secondary content player for playing secondary contents, communication receivers for recognizing distribution of secondary contents, etc. Pieces of digital watermarking embedding equipment are provided in the broadcasting station and the broadcasting receiver respectively. Pieces of digital watermarking extraction equipment are provided in the network monitoring agent and the secondary content player. Particularly, the broadcast contents are outputted through an analog output or an internal disk. Identification information is embedded using digital watermarking having robustness to analog processing. Further, the identification information includes specific information for specifying a device or a user.

### BACKGROUND OF THE INVENTION

The present invention relates to a system for distributing broadcast contents, and particularly relates to a technique effectively applicable to distribution systems, services and media using digital watermarking to protect copyright of broadcast contents.

Watermark and information hiding technology is disclosed in F. A. P. Petitocolas, et al., Information Hiding-A Survey, Proc. of IEEE special issue on Protection of Multimedia Content, http://citeseet, nj. nec.com/petitcolas 99 information, html, July 1999 87(7), pp.1062-1064; CIDf Specification, http://www.cidf.org/english/download, html, September 2002, pp.60-63; V. Solachidis, et al., CIRCULARLY SYMMETRIC WATERMARK EMBEDDING IN 2-D DFT DOMAIN, Proc. of 1999 IEEE Conf. on Acoustics, Seech, and Signal Processing, Vol. 6, pp.3469-3472; and W. Bender, et al., Techniques for data hiding, 1996, http://www.almaden.ibm.com/cs/people/dgruhl/313.pdf, the disclosure of which are incorporated herein by reference.

### SUMMARY OF THE INVENTION

It is an object of the present invention to provide a system for distributing broadcast contents, in which the copyright of the broadcast contents can be protected.

According to the researches of the present inventor, the following technologies can be considered in connection with the system for distributing broadcast contents.

For example, along with digitization of broadcasting, frequency band has been effectively used and it has become possible to broadcast high-definition and high-quality-sound contents on many channels. In addition, it has become possible to provide various novel services such as digital recording, bidirectional broadcasting, and data broadcasting. On the other hand, as more and more video or audio contents are distributed by way of high-capacity media such as DVD, and the Internet is made broadband, it has become possible to provide distribution service of video or audio contents through networks. In short, with the development of digitization technology, broadcasting and media using the technology, and network technology, a wide variety of contents services have become available.

On the other hand, as a negative side effect of these technologies, however, illegal copy of high-quality-image and high-quality-sound broadcast contents and distribution of these illegally copied broadcast contents through media or the Internet have become easy. There is therefore concern that copyright of broadcasting stations, program production companies, material providers, etc. is infringed.

In order to cope with this concern, currently, copyright protection technology such as CAS (Conditional Access System) in which cryptography, authentication and tamper resistance hardware are combined is applied to broadcasting receivers. This copyright protection technology does achieve some effect.

However, since broadcasting receivers have various outputs such as an output to digital recorders, analog SD (Standard Definition) and HD (High Definition) outputs, etc., a loophole of making illegal copies is still exploited broadly. In addition, there is another fact that broadcasting receivers and peripheral devices mounted with no copyright protection technology have been already in widespread use. In consideration of these facts, it cannot be said that currently available copyright protection technologies are sufficient-enough.

On the other hand, digital watermarking technology for embedding copyright information into contents has been developed as a new element technology for copyright protection, and has come under investigation for application to video or music contents on DVDs. It is expected that current copyright protection technologies can be complemented by use of digital watermarking.

In the procedure of broadcasting, the following threats related to copyright piracy can be presumed, for example, as shown in FIG. 7. (A) In the phase where a broadcasting station transmits broadcast content and a broadcast user receives the content, a third person having no license receives and analyzes the radio wave without permission, and uses the content. (B) In the phase where the broadcasting station permits/grants use license of broadcast contents to a broadcast user, the broadcast user uses the use license beyond the range defined in the agreement (access beyond a specified period of time or by use of a terminal other than a specified terminal, or the like). (C) In the phase where the broadcasting station charges/collects a use fee to/from a broadcast user, the broadcast user cooks up the use fee. (D) In the phase where a broadcast user watches/accumulates broadcast content, the broadcast user illegally copies and redistributes the content decrypted for watching or the accumulated content.

If illegally copied content is made up based on the threat (D), it can be presumed that real damage is done through the following process, for example, as shown in FIG. 8. (E) A secondary content distributor distributes the illegally copied content. (F) A secondary user watches the illegally copied content.

In the background art, first, countermeasures using CAS are taken against the threats (A), (B) and (C). CAS is a system for limiting users who can watch broadcasting. For example, in CAS (B-CAS) for BS digital broadcasting, broadcast content subjected to encryption processing (scrambling) is delivered. Only when a legal broadcast user watches broadcast content based on an agreement, decryption is permitted through administration of a work key and a scramble key based on a master key stored in an IC card and distributed to the broadcast user.

In this CAS, broadcast content is protected by cryptography, and of the keys for the cryptography, the work key and the scramble key are protected by the master key, while the master key is protected by the IC card. Using a technique called tamper resistance processing, the IC card can be prevented from being invaded. In such a manner, CAS is an established technology for offering a firm copyright protection function. The remaining threat (D) (illegal copies of contents decrypted for watching or accumulated contents) becomes therefore an issue of great concern.

Broadcasting receivers leave four routes to the threat of illegal copies, that is, (D-1) prizing an apparatus open, (D-2) via a digital signal output, (D-3) via an internal disk, and (D-4) via an analog signal output.

(D-1) Prizing Apparatus Open

Such an attack that an apparatus is prized open and a probe is connected to an internal terminal of an LSI so as to record an ongoing waveform in real time or read data on an internal bus is presumed. Against such a threat, a broadcasting receiver is provided with tamper resistance processing. The tamper resistance processing is an established technology for offering firm protection.

(D-2) Via Digital Signal Output

Such a method that not a monitor but a recorder is connected to a digital signal output of a broadcasting receiver so as to illegally copy broadcast content exists as a threat. Countermeasures against such a threat are taken on the basis of rules such as DTCP or HDCP.

DTCP is a standard for preventing illegal copies through IEEE 1394. According to DTCP, any one of “freely-copy”, “copy-prohibitive”, “one-generation-copy-permissive” and “no-more-copies” is identified and administered for each piece of data. In addition, it is confirmed that a data output destination device is a device conforming to the standard. Further, the classification of the device is recognized, and it is judged from the recognition whether data should be transmitted or not. For example, when broadcast content labeled as “copy-prohibitive” is outputted from the digital signal output, the output destination device is identified as a monitor or a recorder through authentication, and control is made so that the content is outputted when the device is a monitor, and the content is not outputted when the device is a recorder. Further, data is encrypted when it is transmitted. Thus, theft on a communication path is prevented.

HDCP is a specification defining authentication, encryption, etc. in case of outputting digital signals of content to a digital monitor. DTCP and HDCP are established technologies for offering firm protection.

(D-3) Via Internal Disk

Some broadcasting receivers have a function of PVR (Personal Video Recorder) with an internal disk. While there is a user's merit that broadcast contents accumulated in the disk can be reproduced and played at user's leisure, it also means that there is a threat that the internal disk is analyzed to copy broadcast contents illegally.

As a countermeasure against this threat, a convention is established in PVR so that all broadcast contents have to be encrypted when these broadcast contents are stored in a disk. In other words, this arrangement is intended to make data incapable of being played as content even if the data were extracted.

(D-4) Via Analog Signal Output

There is a threat that SD and HD analog signal outputs are recorded.

First, a technology using pseudo sync-pulses is the most typical countermeasure against the threat via the SD analog signal output. According to this technology, a special signal is embedded in a part of a video signal in advance so as to perform access control. Indeed dishonesty prevention using the pseudo sync-pulses does have some effect, but is not perfect.

On the other hand, CGMS-A (Copy Generation Management System on Analog Interface) Standard is provided against the threat via the HD analog signal output. According to CGMS-A, copy control information (freely-copy, one-generation-copy-permissive, copy-prohibitive, etc.) is embedded into signals to be outputted so that copy control can be performed on the side of peripheral devices receiving the signals.

As described above, the dishonesties (A), (B) and (C) presumed in the regular flow of contents can be prevented by CAS. However, as for the dishonesty (D), particularly the illegal copies (D-4) via analog output, the countermeasure against the illegal copies is not perfect.

To prevent illegal copies in the extension of the background art such as cryptograph or authentication, standard equipment based on cryptograph or authentication technology is required on the peripheral device side. For example, when video broadcast content labeled as copy-prohibitive is received, the device connected to the analog output of the broadcasting receiver is identified as a monitor or a recorder through device authentication by use of such equipment. Then, control can be made so that the content is outputted when the device is a monitor, and the content is not outputted when the device is recorder.

However, peripheral devices are used not only for broadcast applications but also for other fields. It is therefore difficult to enforce new standardization rules on the peripheral devices. Further, it is difficult for the market to accept such a manner against the user's merit that peripheral devices which have been already used are forbidden to use because they are regarded as devices having no response to device authentication. It is therefore difficult to prevent illegal copies perfectly in the extension of the background art such as cryptograph or authentication.

On the other hand, digital watermarking is a technology for embedding information into content such as movie or music and detecting the information from the content. The information is embedded by making a subtle change to the content. In other words, the information is expressed by the place of the change and the details of the change, so that the original content and the information-embedded content are different from each other slightly though human beings regard these two kinds of contents as identical to each other visually or aurally. The embedded information is detected by reading the change made in the content.

For example, as disclosed in “Information Security Cryptography and Digital Watermarking in the Internet Age” (2000), such digital watermarking has the following features. Information cannot be removed from content easily because the information is not described in the header or the like of the content but embedded into the content itself. According to some digital watermarking systems, embedded information can be detected even after various image processings such as lossy compression such as JPEG or MPEG, filtering such as smoothing, partial segmentation, etc. In addition, some digital watermarking systems can detect embedded information by redigitizing even after conversion into an analog signal is performed.

In addition, according to the digital watermarking, content in which information has been embedded has the same format as content in which information has not been embedded. Accordingly, a special system is indeed required for embedding and detecting information, but no special system is required for recording, transferring and processing the content.

However, as a result of researches of the present inventor carried out on the aforementioned system for distributing such broadcast contents, the following facts are found.

For example, the system configuration in which users of broadcast contents pay values to copyright holders of the contents stimulates the motive of producers of broadcast contents for producing the broadcast contents. Such positive feedback can make the broadcasting culture as a whole widespread. The background-art copyright protection technologies, however, have a problem that illegal copies via analog outputs of broadcasting receivers cannot be prevented perfectly. Therefore, copyright protection has been an issue of great concern.

In order to cope with this concern, digital watermarking is expected as an element technology to play a role in complementing the background art. Particularly, digital watermarking can be put into effective use in detecting and reporting execution and distribution of illegal copies. However, no specific information about a method for using digital watermarking, a method for copyright protection of broadcast contents, a system for copyright protection, and service using the system has been disclosed heretofore.

The aforementioned object of the invention is attained by the following structure. That is, a watermarking application system for broadcast contents copyright protection according to the present invention includes a broadcasting station for transmitting broadcast contents, a broadcasting receiver for receiving the broadcast contents, a network monitoring agent for monitoring secondary contents of the broadcast contents, a secondary content player for playing secondary contents of the broadcast contents, and so on. Then, embedding element for embedding digital watermarking and extraction element for extracting the digital watermarking are provided in those constituent devices optionally. Further, the watermarking application system may further include a communication receiver for receiving an extraction result of digital watermarking, and recognizing distribution of the secondary contents.

For example, in the watermarking application system for broadcast contents copyright protection according to the present invention, the digital watermarking embedding element is provided in the broadcasting station and/or the broadcasting receiver, and the digital watermarking extraction element is provided in the network monitoring agent and/or the secondary content player. Particularly, the broadcast contents are outputted as analog outputs, while the identification information for identifying the copyright of the broadcast contents is embedded by use of digital watermarking having robustness to analog processing (using a manner having robustness to image processing including analog conversion). Further, the identification information may include specific information (including an ID, a master key and a license key) for specifying a device or a user thereof.

### BRIEF DESCRIPTION OF THE DRAWINGS

FIG. 1 is a schematic configuration diagram showing a watermarking application system for broadcast contents copyright protection according to a preferred embodiment of the present invention;

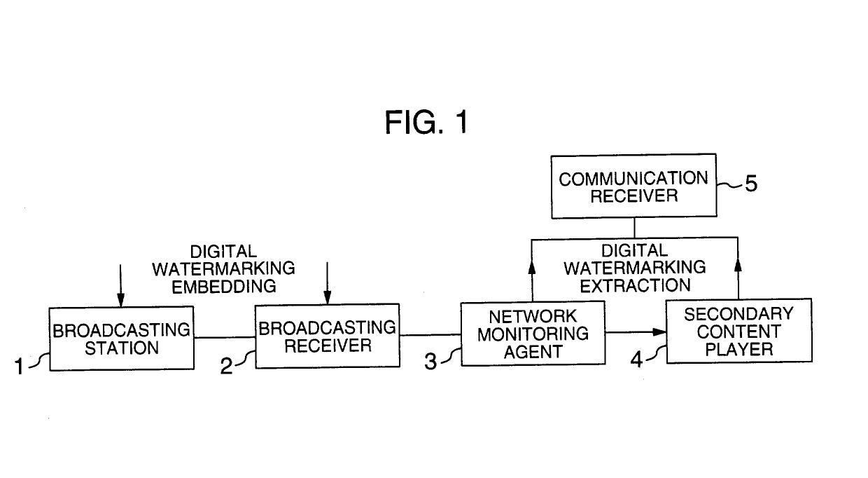

FIGS. 2A and 2B are configuration diagrams showing a watermarking application system for broadcast contents copyright protection according to a first embodiment of the present invention;

FIGS. 3A and 3B are configuration diagrams showing a watermarking application system for broadcast contents copyright protection according to a second embodiment of the present invention;

FIGS. 4A and 4B are configuration diagrams showing a watermarking application system for broadcast contents copyright protection according to a third embodiment of the present invention;

FIGS. 5A and 5B are configuration diagrams showing a watermarking application system for broadcast contents copyright protection according to a fourth embodiment of the present invention;

FIGS. 6A and 6B are configuration diagrams showing a watermarking application system for broadcast contents copyright protection according to a fifth embodiment of the present invention;

FIG. 7 is an explanatory diagram showing broadcast contents protection technologies and threats to those technologies, stated as a premise of the present invention; and

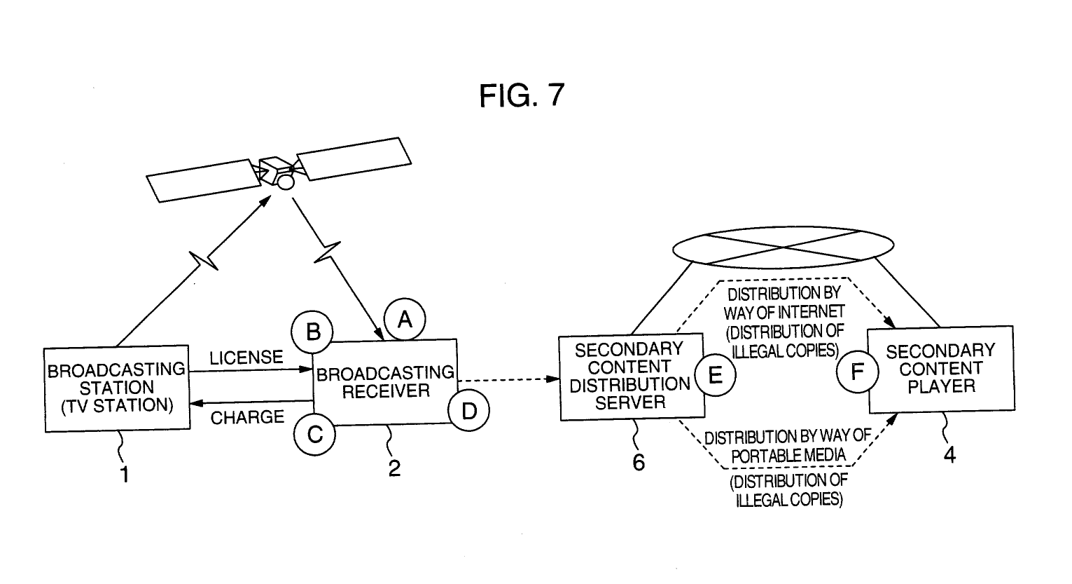

FIG. 8 is an explanatory diagram showing distribution of illegal copies of broadcast contents, stated as a premise of the present invention.

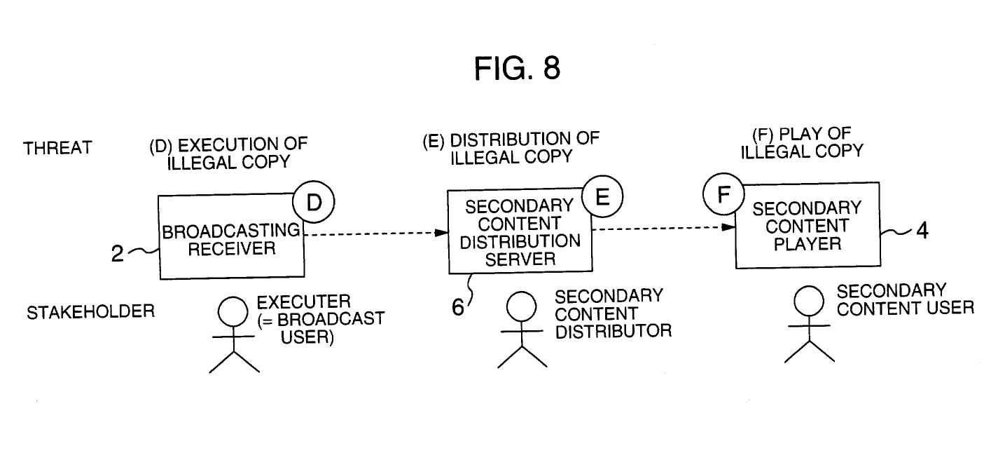

### DETAILED DESCRIPTION OF THE EMBODIMENTS

Embodiments of the present invention will be described below in detail with reference to the drawings. Incidentally, members having the same function are denoted by the same reference number correspondingly in all the drawings for explaining the embodiments, and repeated description on those members will be therefore omitted.

In a preferred embodiment of the present invention, a watermarking application system for broadcast contents copyright protection is constituted by a broadcasting station 1, a broadcasting receiver 2, a network monitoring agent 3, a secondary content player 4, a communication receiver 5, etc. In this system, embedding element for embedding digital watermarking and extraction element for detecting the digital watermarking are provided optionally in the broadcasting station 1, the broadcasting receiver 2, the network monitoring agent 3 and the secondary content player 4. In addition, when secondary content is deterred, the communication receiver 5 is notified of that fact so that an appropriate countermeasure is taken.

Specifically, there can be considered five cases, that is, (1) the case where digital watermarking is embedded in the broadcasting station 1 and detected in the network monitoring agent 3 (first embodiment), (2) the case where watermarking is embedded in the broadcasting station 1 and detected in the secondary content player 4 (second embodiment), (3) the case where watermarking is embedded in the broadcasting receiver 2 and detected in the network monitoring agent 3 (third embodiment), (4) the case where watermarking is embedded in the broadcasting receiver 2 and detected in the secondary content player 4 (fourth embodiment), and (5) the case where the previous cases are combined (fifth embodiment). The cases will be described below sequentially.

Incidentally, main terms used in the embodiments will be described. That is, “broadcast content” means content of video, audio, etc. to be broadcast; “broadcast user” means a subject watching the broadcast content; “secondary content” means content obtained by copying and editing the broadcast content, and distributed by way of a network or portable media; “secondary content distributor” means a subject distributing the secondary content; and “secondary content user” means a subject watching the secondary content.

In addition, in the embodiments, digital watermarking uses a manner having robustness to image processing including analog conversion. The digital watermarking having robustness to analog processing means digital watermarking in which some kind of information embedded in digital content can be extracted from the content once converted into an analog signal and then redigitized. Such a conversion process is referred to as DA/AD (digital-to-analog/analog-to-digital) conversion. In the DA/DA conversion, the content is subjected to image processing or acoustic processing such as smoothing, scaling, and the like. Therefore, digital watermarking having no robustness to analog processing can be lost in the conversion process. However, the digital watermarking having robustness to analog processing survives in the content after the conversion so that the embedded information can be detected.

It is technically possible to put it into practice that the digital watermarking having robustness to analog processing is applied to broadcast contents. Accordingly, digital watermarking having robustness to analog processing will be obtained. See, for example, V. Solachidis, et al., CIRCULARLY SYMMETRIC WATERMARK EMBEDDING IN 2-D DFT DOMAIN, Proc. of 1999 IEEE Conf. on Acoustics, Seech, and Signal Processing, Vol. 6, pp.3469-3472.

In addition, the document W. Bender, et al., Techniques for data hiding, 1996, http://www.almaden. ibm.com/cs/people/dgruhl/313.pdf discloses a specific method for mounting digital watermarking. According to this method, two points extracted from an image are artificially changed in brightness repeatedly so that digital watermarking information can be embedded as statistic. This statistic is constant in principle in image processing applied homogeneously to the whole image such as smoothing filtering or resolution conversion. However, when analog copying is repeated so that image processing is performed to spoil the worthy of admiration, there is a possibility that the digital watermarking is lost. For example, it can be considered that if smoothing is repeated a very large number of times, all the colors will be mixed to obtain a picture painted in gray as a whole. In this case, not only the digital watermarking but also the value of the original picture are lost. According to the method disclosed in the aforementioned document, it is impossible to separate the digital watermarking without spoiling the original picture. If this principle is applied, digital watermarking having sufficient robustness to analog processing can be put into practice easily.

The broadcast content first suffers DA conversion in the process in which the broadcast content is outputted from the broadcasting receiver to the monitor through an analog output terminal or an internal disk. Next, when illegal copying is performed with a video capture system or the like connected in place of the monitor, the broadcast content suffers AD conversion by redigitization. At this time, robustness to image processing and acoustic processing in the DA/AD conversion is technically equivalent to the existing robustness to analog processing (robustness to smoothing, scaling, and the like). Accordingly, in the embodiments, the manner of digital watermarking having robustness to analog processing is adopted for broadcast contents.

First Embodiment

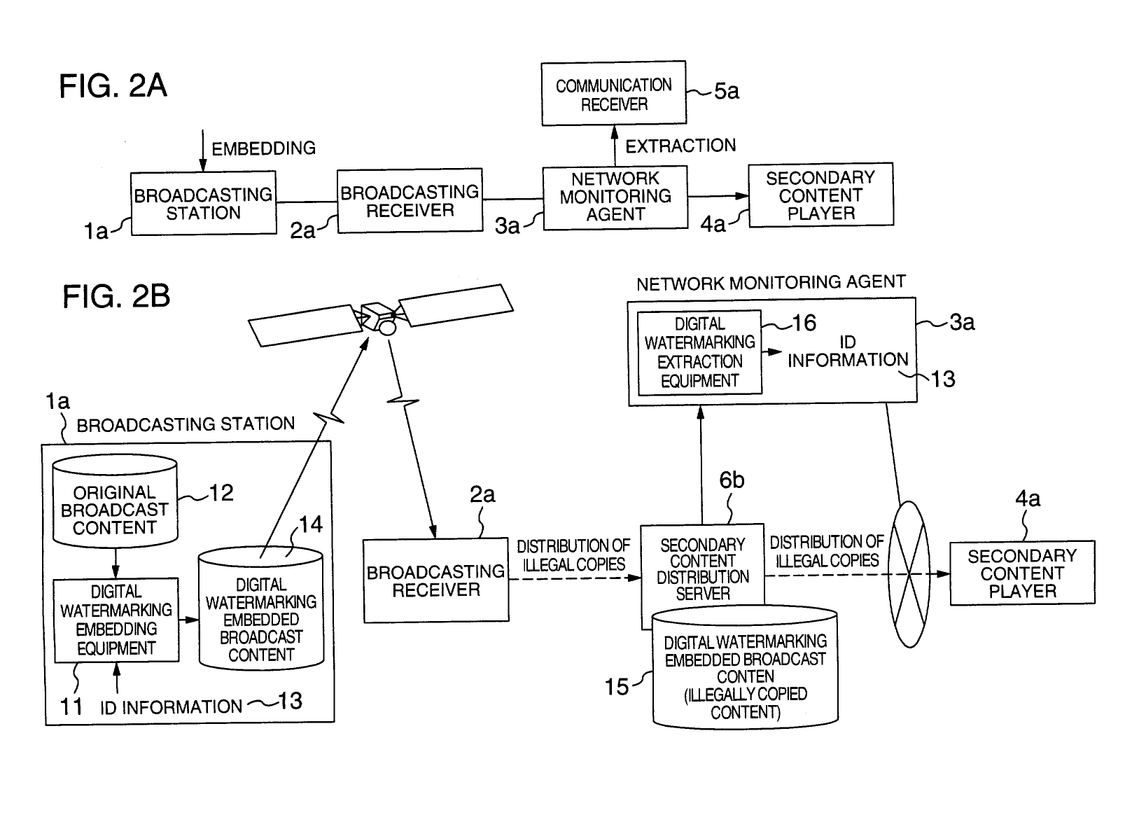

The configuration of a watermarking application system for broadcast contents copyright protection according to a first embodiment of the present invention will be described with reference to FIGS. 2A and 2B by way of example. FIGS. 2A and 2B are configuration diagrams of the watermarking application system for broadcast contents copyright protection according to this embodiment. FIG. 2A is a diagram conceptually showing the place where embedding of digital watermarking is carried out and the place where extraction of the digital watermarking is carried out, and FIG. 2B is a diagram showing these places specifically.

The watermarking application system for broadcast contents copyright protection according to this embodiment is applied to the case where digital watermarking is embedded in a broadcasting station and detected in a network monitoring agent by way of example. The system is constituted by a broadcasting station 1a, a broadcasting receiver 2a, a secondary content distribution server 6a, a secondary content player 4a, a network monitoring agent 3a, a communication receiver 5a, etc. The secondary content distribution server 6a, the secondary content player 4a and the network monitoring agent 3a are connected through a network.

In this watermarking application system for broadcast contents copyright protection, a radio signal is transmitted/received from the broadcasting station 1a to the broadcasting receiver 2a on a regular broadcasting path. The distribution path on which illegal copies are distributed via a network is taken from the broadcasting receiver 2a to the secondary content player 4a through the secondary content distribution server 6a. Incidentally, a distribution path by way of portable media without passing through any network can be also considered as the path from the secondary content distribution server 6a to the secondary content player 4a. This distribution path can be covered by the case where the place to extract digital watermarking therein is provided in the secondary content player 4a, which will be described later by way of example.

The broadcasting station 1a is a device including a function of transmitting broadcast contents. The broadcasting station 1a is provided with digital watermarking embedding equipment 11 which is the embedding element for embedding digital watermarking. Identification information 13 for identifying copyright of original broadcast content 12 is embedded into the original broadcast content 12 by the digital watermarking embedding equipment 11, and transmitted as digital watermarking embedded broadcast content 14. Incidentally, information for specifying the copyright holder of the original broadcast content 12, the broadcasting station 1a, or the like, can be used as the identification information 13 to be embedded as digital watermarking. Such embedding of digital watermarking by the digital-watermarking embedding equipment 11 is performed, for example, in a predetermined algorithm.

The broadcasting receiver 2a is a device including a function of receiving broadcast contents. The digital watermarking embedded broadcast content 14 transmitted from the broadcasting station 1a is received in this broadcasting receiver 2a, and watched by a broadcast user. The digital watermarking embedded broadcast content 14 is outputted from the broadcasting receiver 2a via its analog output or its internal disk.

The secondary content distribution server 6a is a device including a function of distributing secondary contents of broadcast contents. For example, if there is a broadcast user illegally copying the digital watermarking embedded broadcast content 14 received by the broadcasting receiver 2a, digital watermarking embedded broadcast content (illegally copied content) 15 will be issued as illegally copied content to the secondary content distribution server 6a. The digital watermarking embedded broadcast content (illegally copied content) 15 becomes a secondary content.

The secondary content player 4a is a device including a function of playing secondary contents of broadcast contents. For example, if the digital watermarking embedded broadcast content (illegally copied content) 15 which is a secondary content is issued out, the secondary content will be illegally watched in the secondary content player 4a by a secondary content user.

The network monitoring agent 3a is a device including a function of monitoring secondary contents of broadcast contents. The network monitoring agent 3a is provided with digital watermarking extraction equipment 16 which is the extraction element for detecting digital watermarking. Digital watermarking detection processing is performed on secondary content, and the identification information 13 embedded in the secondary content is detected by the digital watermarking extraction equipment 16. For example, assume that on the basis of the extraction result of the identification information 13 embedded in the digital watermarking embedded broadcast content (illegally copied content) 15, the network monitoring agent 3a deters the fact that the secondary content distribution server 6a has distributed the illegally copied secondary content. In this case, the network monitoring agent 3a notifies the communication receiver 5a of that fact. The digital watermarking detection processing by the digital watermarking extraction equipment 16 is carried out, for example, in a predetermined algorithm.

The communication receiver 5a is a device including a function of receiving the extraction result of digital watermarking and recognizing the distribution of secondary contents. In response to a notice from the network monitoring agent 3a, the communication receiver 5a takes a countermeasure, for example, to urge a secondary content distributor distributing illegal copied secondary content to stop the distribution.

Next, the procedure of operation in the watermarking application system for broadcast contents copyright protection according to this embodiment will be described.

First, in the broadcasting station 1a such as a TV station, identification information 13 of original broadcast content 12 (or the TV station) is embedded into the original broadcast content 12 by the digital watermarking embedding equipment 11. Further, digital watermarking embedded broadcast content 14 in which the identification information 13 has been embedded in the original broadcast content 12 is transmitted from the broadcasting station 1a. Then, the transmitted digital watermarking embedded broadcast content 14 is received by the broadcasting receiver 2a, and a broadcast user watches the digital watermarking embedded broadcast content 14. The path so far is a regular broadcasting path.

Here, for example, assume that there is a broadcast user executing illegal copies. In this case, the digital watermarking embedded broadcast content 14 is issued as secondary content of the digital watermarking embedded broadcast content (illegally copied content) 15 to the secondary content distribution server 6a. Then, the illegally copied secondary content issued out can be distributed to the secondary content player 4a through a network and further watched illegally by a secondary content user through the secondary content player 4a.

However, in the network monitoring agent 3a connected to the network, the digital watermarking extraction equipment 16 applies digital watermarking detection processing to the secondary content of the digital watermarking embedded broadcast content (illegally copied content) 15, deters the fact that the secondary content has been distributed, and extracts the identification information 13 embedded therein. When the fact that a secondary content distribution server 6a has distributed the secondary content is deterred based on the extracted identification information 13, the network monitoring agent 3a notifies the communication receiver 5a of that fact. Thus, the communication receiver 5a can take a countermeasure, for example, to urge the secondary content distributor to stop the distribution.

As described above, according to the watermarking application system for broadcast contents copyright protection in this embodiment, the following effects can be obtained based on digital watermarking embedded in the broadcasting station 1a and detected in the network monitoring agent 3a.

(1) The cost is extremely low. This is because the digital watermarking embedding equipment 11 may be installed in at least one place of a TV station or the like having the broadcasting station 1a, and the digital watermarking extraction equipment 16 may be installed in at least one place of the network monitoring agent 3a. The cost here means equipment expenses and personnel expenses required for introducing the system using digital watermarking.

(2) Since there is no linkage with any other industry or no restriction therefrom, possibility is extremely high. The possibility here means lowness in degree of social friction that might arise from the introduction of the system. For example, a system closed in the broadcasting industry has high possibility because stakeholders share a mutual interest. However, as the portion concerned with other industries increases, the possibility becomes lower because adjustment among stakeholders is required.

(3) There is an effect of protection/recovery. For example, information specifying broadcast content can be embedded in a broadcasting station or the like. Accordingly, illegal copies can be deterred by the network monitoring agent 3a.

Second Embodiment

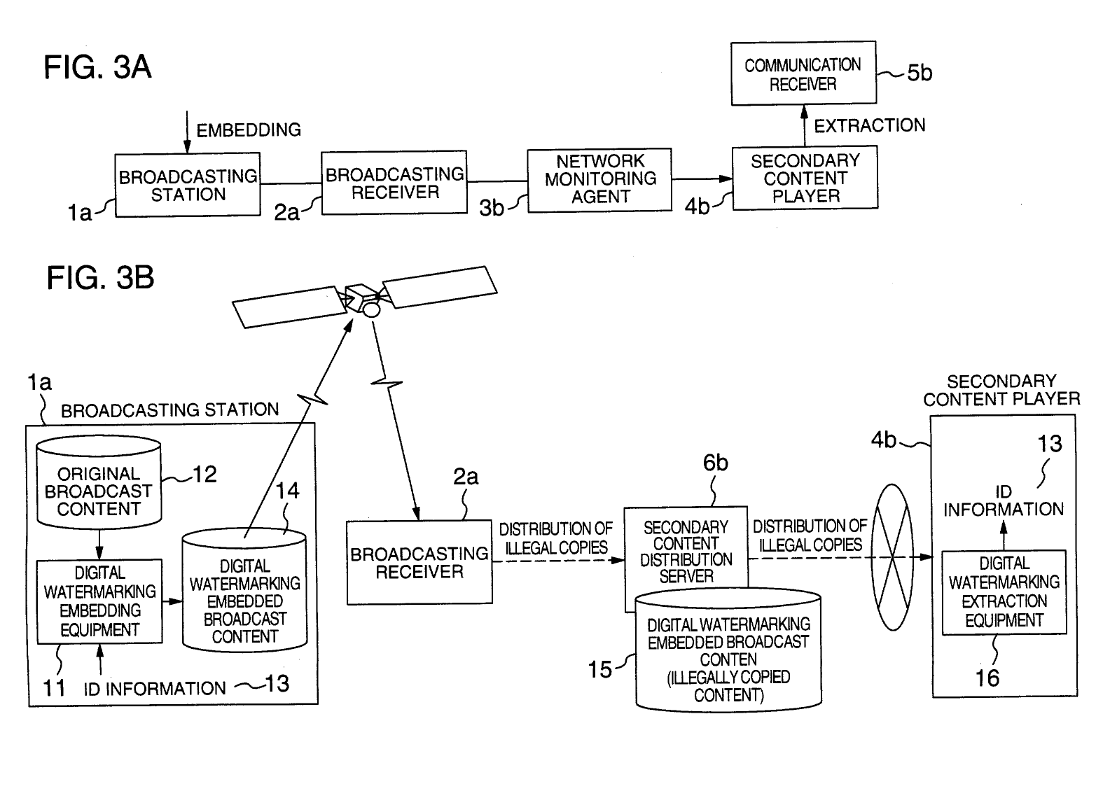

The configuration of a watermarking application system for broadcast contents copyright protection according to a second embodiment of the present invention will be described with reference to FIGS. 3A and 3B by way of example. FIGS. 3A and 3B are configuration diagrams of the watermarking application system for broadcast contents copyright protection according to this embodiment. FIG. 3A is a diagram conceptually showing the place where embedding of digital watermarking is carried out and where extraction of the digital watermarking is carried out, and FIG. 3B is a diagram showing these places specifically.

The watermarking application system for broadcast contents copyright protection according to this embodiment is applied to the case where digital watermarking is embedded in a broadcasting station and detected in a secondary content player by way of example. The system is constituted by a broadcasting station 1a, a broadcasting receiver 2a, a secondary content distribution server 6a, a secondary content player 4b, a network monitoring agent 3b, a communication receiver 5b, etc., in the same manner as that in the first embodiment. The system in the second embodiment is different from that in the first embodiment in that the secondary content player 4b in place of the network monitoring agent is provided with digital watermarking extraction equipment 16 which is the extraction element for detecting digital watermarking.

That is, in the secondary content player 4b according to this embodiment, the digital watermarking extraction equipment 16 is provided to perform digital watermarking detection processing on secondary content. Thus, identification information 13 embedded in the secondary content is detected by the digital watermarking extraction equipment 16. Accordingly, the network monitoring agent 3b is not always required in this embodiment.

In such a configuration, the procedure of operation in the watermarking application system for broadcast contents copyright protection according to this embodiment is carried out in the same manner as in the first embodiment. That is, digital watermarking embedded broadcast content 14 transmitted from the broadcasting station 1a such as a TV station is received in the broadcasting receiver 2a. For example, when there is a broadcast user executing illegal copies, secondary content of digital watermarking embedded broadcast content (illegally copied content) 15 is issued to the secondary content distribution server 6a, and distributed to the secondary content player 4b through a network. Thus, the secondary content can be illegally watched by a secondary content user.

However, in this embodiment, the secondary content player 4b is provided with the digital watermarking extraction equipment 16. Thus, the digital watermarking extraction equipment 16 applies digital watermarking detection processing to the secondary content of the digital watermarking embedded broadcast content (illegally copied content) 15, deters the fact that the secondary content has been distributed, and extracts the identification information 13 embedded therein. When the fact that a secondary content distribution server 6a has distributed the secondary content is deterred based on the extracted identification information 13, the secondary content user can notify the communication receiver 5b of that fact. Thus, the communication receiver 5b can take a countermeasure, for example, to urge the secondary content distributor to stop the distribution.

Incidentally, when the digital watermarking extraction equipment 16 is provided in the secondary content player 4b as in this embodiment, it is possible to apply the digital watermarking detection processing also to secondary content of digital watermarking embedded broadcast content (illegally copied content) 15 distributed by way of portable media without passing through the network, and deter the fact that the secondary content has been distributed. Thus, it is possible to take a countermeasure to the secondary content distributor in the same manner.

As described above, according to the watermarking application system for broadcast contents copyright protection in this embodiment, the following effects can be obtained based on digital watermarking embedded in the broadcasting station 1a and detected in the secondary content player 4b.

(1) The cost is low because it costs merely correspondingly to the number of secondary content players 4b.

(2) Possibility is high because the linkage with any other industry or the restriction therefrom is limited.

(3) There is an effect of protection/recovery. For example, information specifying broadcast content can be embedded in a broadcasting station or the like. Accordingly, illegal copies can be deterred by the secondary content player 4b. The determent performance in the secondary content player 4b is higher than the determent performance in the network monitoring agent as in the first embodiment.

Third Embodiment

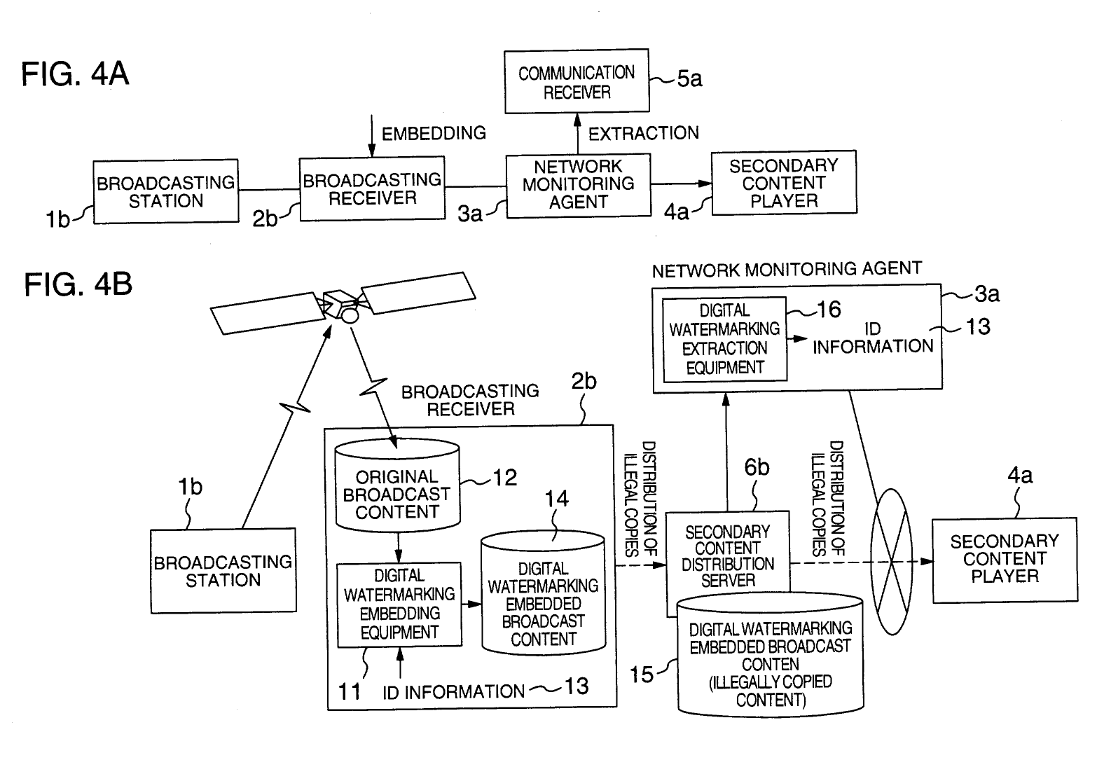

The configuration of a watermarking application system for broadcast contents copyright protection according to a third embodiment of the present invention will be described with reference to FIGS. 4A and 4B by way of example. FIGS. 4A and 4B are configuration diagrams of the watermarking application system for broadcast contents copyright protection according to this embodiment. FIG. 4A is a diagram conceptually showing the place where embedding of digital watermarking is carried out and the place where extraction of the digital watermarking is carried out, and FIG. 4B is a diagram showing these places specifically.

The watermarking application system for broadcast contents copyright protection according to this embodiment is applied to the case where digital watermarking is embedded in a broadcasting receiver and detected in a network monitoring agent by way of example. The system is constituted by a broadcasting station 1b, a broadcasting receiver 2b, a secondary content distribution server 6a, a secondary content player 4a, a network monitoring agent 3a, a communication receiver 5a, etc., in the same manner as that in the first embodiment. The system in the third embodiment is different from that in the first embodiment in that the broadcasting receiver 2b in place of the broadcasting station is provided with digital watermarking embedding equipment 11 which is the embedding element for embedding digital watermarking.

That is, in the broadcasting receiver 2b according to this embodiment, the digital watermarking embedding equipment 11 is provided. Thus, identification information 13 for identifying copyright of received original broadcast content 12 is embedded into the original broadcast content 12 by the digital watermarking embedding equipment 11, and transmitted as digital watermarking embedded broadcast content 14. Accordingly, in this embodiment, information specifying the broadcasting receiver 2b, an individual broadcast user, or the like, can be used as the identification information 13 to be embedded as digital watermarking. Examples of such information include attribute information such as an ID, a master key, a license key, etc. granted to each device or each individual.

In such a configuration, the procedure of operation in the watermarking application system for broadcast contents copyright protection according to this embodiment is carried out as follows. First, original broadcast content 12 is transmitted from the broadcasting station 1b such as a TV station. Then, the original broadcast content 12 is received in the broadcasting receiver 2b. A broadcast user watches the original broadcast content 12. At the same time, the identification information 13 is embedded into the original broadcast content 12 by use of the digital watermarking embedding equipment 11, and transmitted as digital watermarking embedded broadcast content 14.

At this time, for example, when there is a broadcast user executing illegal copies, secondary content of digital watermarking embedded broadcast content (illegally copied content) 15 is issued to the secondary content distribution server 6a, and distributed to the secondary content player 4b through a network in the same manner as in the first embodiment. Thus, the secondary content can be illegally watched by a secondary content user. However, when the digital watermarking extraction equipment 16 in the network monitoring agent 3a extracts the embedded identification information 13 and detects the fact that a secondary content distribution server 6a has distributed the secondary content, the network monitoring agent 3a notifies the communication receiver 5a of that fact. Thus, the communication receiver 5a can take a countermeasure, for example, to urge the secondary content distributor to stop the distribution.

As described above, according to the watermarking application system for broadcast contents copyright protection in this embodiment, the following effects can be obtained based on digital watermarking embedded in the broadcasting receiver 2b and detected in the network monitoring agent 3a.

(1) The cost is low because it costs merely correspondingly to the number of broadcasting receivers 2b.

(2) Possibility is extremely high because there is no linkage with any other industry or no restriction therefrom.

(3) Since specific information (e.g. number of a receiver) of a broadcast user can be embedded, it is possible to specify who has got involved in such dishonesty. That is, the effect of protection/recovery against execution of illegal copies is extremely great.

Fourth Embodiment

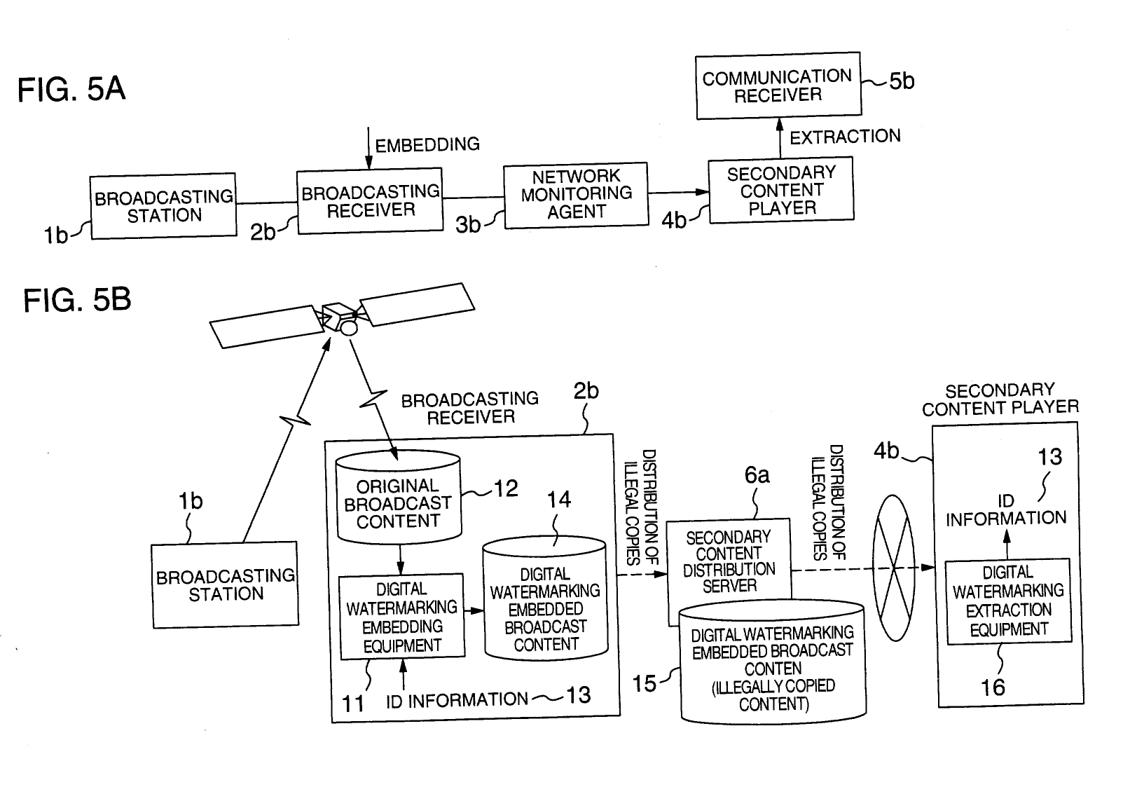

The configuration of a watermarking application system for broadcast contents copyright protection according to a fourth embodiment of the present invention will be described with reference to FIGS. 5A and 5B by way of example. FIGS. 5A and 5B are configuration diagrams of the watermarking application system for broadcast contents copyright protection according to this embodiment. FIG. 5A is a diagram conceptually showing the place where embedding of digital watermarking is carried out and the place where extraction of the digital watermarking is carried out, and FIG. 5B is a diagram showing these places specifically.

The watermarking application system for broadcast contents copyright protection according to this embodiment is applied to the case where digital watermarking is embedded in a broadcasting receiver and detected in a secondary content player by way of example. The system is constituted by a broadcasting station 1b, a broadcasting receiver 2b, a secondary content distribution server 6a, a secondary content player 4b, a network monitoring agent (not always required) 3b, a communication receiver 5b, etc., in the same manner as in the second embodiment. The system in the fourth embodiment is different from that in the second embodiment in that the broadcasting receiver 2b in place of the broadcasting station is provided with digital watermarking embedding equipment 11 which is the embedding element for embedding digital watermarking.

That is, this embodiment has a configuration in which the secondary content player 4b provided with the digital watermarking extraction equipment 16 in the second embodiment and the broadcasting receiver 2b provided with the digital watermarking embedding equipment 11 in the third embodiment are combined. Accordingly, the procedure of operation in this embodiment also has operation in which the operation in the second embodiment and the operation in the third embodiment are combined.

As described above, according to the watermarking application system for broadcast contents copyright protection in this embodiment, the following effects can be obtained based on digital watermarking embedded in the broadcasting receiver 2b and detected in the secondary content player 4b.

(1) The effect of protection/recovery against execution of illegal copies is extremely great. Since specific information (e.g. number of a receiver) of a broadcast user can be embedded, it is possible for the secondary content player 4b to deter who has got involved in such dishonesty. The determent performance in the secondary content player 4b is higher than the determent performance in the network monitoring agent.

Fifth Embodiment

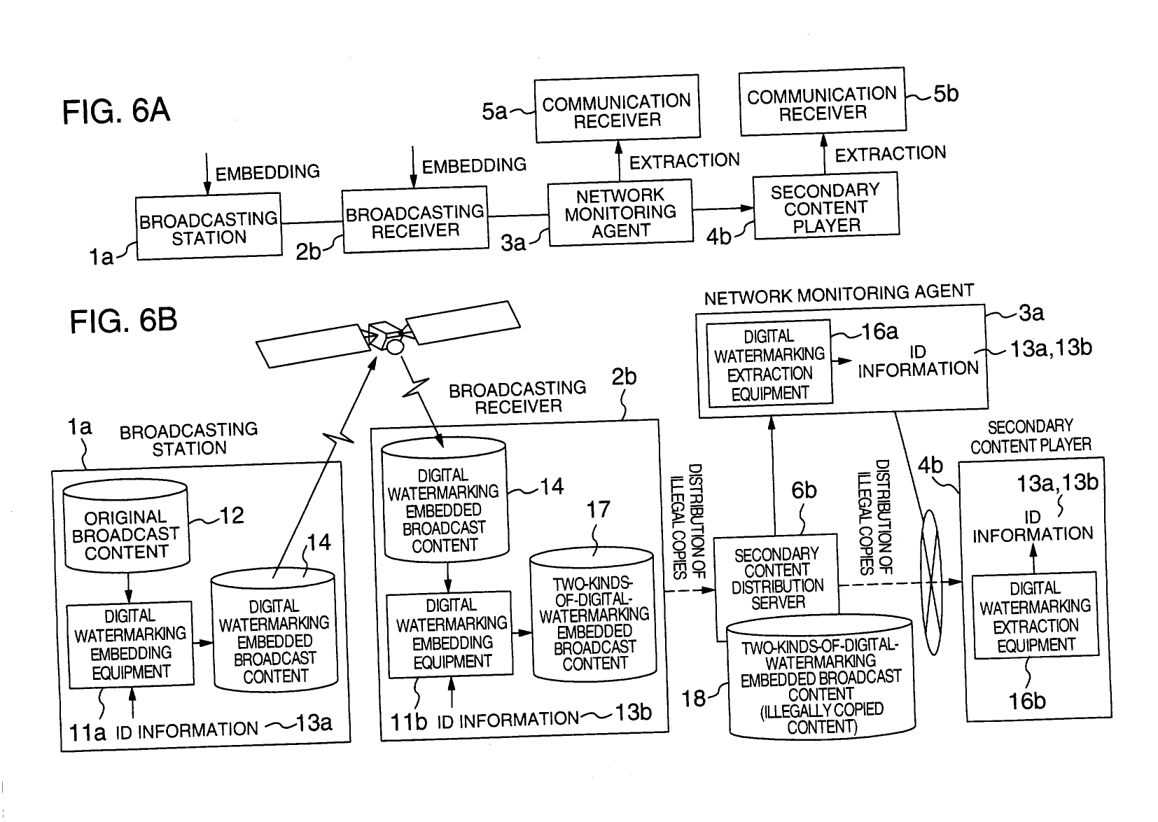

The configuration of a watermarking application system for broadcast contents copyright protection according to a fifth embodiment of the present invention will be described with reference to FIGS. 6A and 6B by way of example. FIGS. 6A and 6B are configuration diagrams of the watermarking application system for broadcast contents copyright protection according to this embodiment. FIG. 6A is a diagram conceptually showing the place where embedding of digital watermarking is carried out and the place where extraction of the digital watermarking is carried out, and FIG. 6B is a diagram showing these places specifically.

The watermarking application system for broadcast contents copyright protection according to this embodiment is applied to the case where digital watermarking is embedded in a broadcasting station and a broadcasting receiver and detected in a network monitoring agent and a secondary content player by way of example. The system is constituted by a broadcasting station 1a, a broadcasting receiver 2b, a secondary content distribution server 6b, a secondary content player 4b, a network monitoring agent 3a, communication receivers 5a and 5b, etc., in the same manner as in the first embodiment. The system in the fifth embodiment is different from that in the first embodiment in that the broadcasting station 1a and the broadcasting receiver 2b are provided with pieces of digital watermarking embedding equipment 11a and 11b which are the embedding element for embedding digital watermarking, respectively, while the network monitoring agent 3a and the secondary content player 4b are provided with pieces of digital watermarking extraction equipment 16a and 16b which are the extraction element for detecting digital watermarking, respectively.

That is, this embodiment has a configuration in which the broadcasting station 1a provided with the piece of digital watermarking embedding equipment 11a and the network monitoring agent 3a provided with the piece of digital watermarking extraction equipment 16a in the first embodiment and the broadcasting receiver 2b provided with the piece of digital watermarking embedding equipment 11b and the secondary content player 4b provided with the piece of digital watermarking extraction equipment 16b in the fourth embodiment are combined, or the broadcasting station 1a provided with the piece of digital watermarking embedding equipment 11a and the secondary content player 4b provided with the piece of digital watermarking extraction equipment 16b in the second embodiment and the broadcasting receiver 2b provided with the piece of digital watermarking embedding equipment 11b and the network monitoring agent 3a provided with the piece of digital watermarking extraction equipment 16a in the third embodiment are combined.

Accordingly, the procedure of operation also has operation in which those operations in the previous embodiments are combined. For example, in the broadcasting station 1a such as a TV station, identification information 13a of original broadcast content 12 (or the TV station) is embedded into the original broadcast content 12 by the piece of digital watermarking embedding equipment 11a. Further, in the broadcasting receiver 2b, identification information 13b specifying the broadcasting receiver 2b or an individual broadcast user is embedded into digital watermarking embedded broadcast content 14 by the piece of digital watermarking embedding equipment 11b, and transmitted as two-kinds-of-digital-watermarking embedded broadcast content 17.

Then, for example, assume that the piece of digital watermarking extraction equipment 16a of the network monitoring agent 3a applies digital watermarking detection processing to two-kinds-of-digital-watermarking embedded broadcast content (illegally copied content) 18, and deters a device carrying the secondary content. In this case, the network monitoring agent 3a notifies the communication receiver 5a of that fact. Thus, the communication receiver 5a can take a countermeasure, for example, to urge a secondary content distributor to stop the distribution. In addition, assume that the piece of digital watermarking extraction equipment 16b of the secondary content player 4b applies digital watermarking detection processing to the two-kinds-of-digital-watermarking embedded broadcast content (illegally copied content) 18, and deters a device distributing the secondary content. In this case, a secondary content user notifies the communication receiver 5b of that fact. Thus, the communication receiver 5b can take a countermeasure, for example, to urge a secondary content distributor to stop the distribution.

As described above, according to the watermarking application system for broadcast contents copyright protection in this embodiment, the previous first to fourth embodiments are combined so that the superior advantages of the first to fourth embodiments can be obtained as effects of this embodiment. Thus, firmer copyright protection can be attained.

Incidentally, when the first to fourth embodiments are combined as in this embodiment, the configuration is not limited to that in FIGS. 6A and 6B, but various combinations can be adopted, including the case where a broadcasting station and a broadcasting receiver are provided with digital watermarking embedding equipment respectively while digital watermarking extraction equipment is provided only in a network monitoring agent; the case where a broadcasting station and a broadcasting receiver are provided with digital watermarking embedding equipment respectively while digital watermarking extraction equipment is provided only in a secondary content player; the case where digital watermarking embedding equipment is provided only in a broadcasting station while a network monitoring agent and a secondary content player are provided with digital watermarking extraction equipment respectively; and the case where digital watermarking embedding equipment is provided only in a broadcasting receiver while a network monitoring agent and a secondary content player are provided with digital watermarking extraction equipment respectively. Also in any of these cases, the superior advantages of the first to fourth embodiments can be obtained as effects of this embodiment.

According to the present invention, digital watermarking is robust to image processing including analog conversion so that execution and distribution of illegal copies can be deterred and reported. Then, copyright of broadcast contents can be protected by five kinds of system configurations, that is, (1) the configuration where digital watermarking is embedded in a broadcasting station, and detected in a network monitoring agent, (2) the configuration where digital watermarking is embedded in a broadcasting station, and detected in a secondary content player, (3) the configuration where digital watermarking is embedded in a broadcasting receiver, and detected in a network monitoring agent, (4) the configuration where digital watermarking is embedded in a broadcasting receiver, and detected in a secondary content player, and (5) the configuration where these configurations are combined. Particularly, firmer copyright protection can be attained by the combination of these configurations.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. A watermarking application system for broadcast contents copyright protection comprising:
a broadcasting station for transmitting broadcast contents; and/or
a broadcasting receiver for receiving said broadcast contents;
wherein said broadcasting station and/or said broadcasting receiver include embedding element for embedding identification information for identifying copyright of said broadcast contents into said broadcast contents by use of digital watermarking.

2. A watermarking application system according to claim 1, further comprising:
a network monitoring agent for monitoring secondary contents of said broadcast contents; and/or
a secondary content player for playing secondary contents of said broadcast contents;
wherein said network monitoring agent and/or said secondary content player include extraction element for carrying out digital watermarking detection processing on said secondary contents, and detecting said identification information embedded in said secondary contents.

3. A watermarking application system for broadcast contents copyright protection comprising:
a network monitoring agent for monitoring secondary contents of broadcast contents; and/or
a secondary content player for playing secondary contents of broadcast contents;
wherein said network monitoring agent and/or said secondary content player include extraction element for carrying out digital watermarking detection processing on said secondary contents, and detecting identification information embedded in said secondary contents for identifying copyright of said broadcast contents.

4. A watermarking application system according to claim 3, further comprising:
a broadcasting station for transmitting said broadcast contents; and/or
a broadcasting receiver for receiving said broadcast contents;
wherein said broadcasting station and/or said broadcasting receiver include embedding means for embedding said identification information into said broadcast contents by means of digital watermarking.

5. A watermarking application system according to claim 2, wherein:
said broadcast contents are contents outputted from said broadcasting station and/or said broadcasting receiver through an analog output thereof; and
said embedding element embeds said identification information by use of digital watermarking having robustness to analog processing.

6. A watermarking application system according to claim 4, wherein:
said broadcast contents are contents outputted from said broadcasting station and/or said broadcasting receiver through an analog output thereof; and
said embedding element embeds said identification information by use of digital watermarking having robustness to analog processing.

7. A watermarking application system according to claim 2, wherein:
said identification information further includes specific information for specifying said broadcasting station and/or said broadcasting receiver, or for specifying a user of said broadcasting station and/or said broadcasting receiver.

8. A watermarking application system according to claim 4, wherein:
said identification information further includes specifying information for specifying said broadcasting station and/or said broadcasting receiver, or for specifying a user of said broadcasting station and/or said broadcasting receiver.

9. A watermarking application system according to claim 7, wherein:
said specific information includes an ID, a master key and a license key set for said broadcasting station and/or said broadcasting receiver, or for a user of said broadcasting station and/or said broadcasting receiver.

10. A watermarking application system according to claim 8, wherein:
said specific information includes an ID, a master key and a license key set for said broadcasting station and/or said broadcasting receiver, or for a user of said broadcasting station and/or said broadcasting receiver.

11. A watermarking application system according to claim 2, further comprising:
a communication receiver for receiving an extraction result obtained by said extraction element, and recognizing distribution of said secondary contents.

12. A watermarking application system according to claim 4, further comprising:
a communication receiver for receiving an extraction result obtained by said extraction element, and recognizing distribution of said secondary contents.

13. A watermarking application system according to claim 11, wherein:
said secondary contents are distributed by way of a network.

14. A watermarking application system according to claim 12, wherein:
said secondary contents are distributed by way of a network.

15. A watermarking application system according to claim 11, wherein:
said secondary contents are distributed by way of portable media.

16. A watermarking application system according to claim 12, wherein:
said secondary contents are distributed by way of portable media.
